(19) United States
(12) Patent Application Publication
(10) Pub. No.: US 2014/0035981 A1
(43) Pub. Date: Feb. 6, 2014

(54) System And Method For Clearing Weak And Missing Inkjets In An Inkjet Printer

(71) Applicants: Edward F. Burress, West Linn, OR (US); Brent R. Jones, Sherwood, OR (US)

(72) Inventors: Edward F. Burress, West Linn, OR (US); Brent R. Jones, Sherwood, OR (US)

(73) Assignee: XEROX CORPORATION, Norwalk, CT (US)

(21) Appl. No.: 13/564,185

(22) Filed: Aug. 1, 2012

(51) Int. Cl. B41J 29/38

(52) U.S. Cl. 347/14

(57) ABSTRACT

An inkjet printer is operated to identify inoperative inkjets without generating test patterns or analyzing image data. The inkjet printer delivers to the inkjet in the printhead a driving signal configured to operate a piezoelectric actuator in the inkjet and receive a response signal from the piezoelectric actuator. The condition of the inkjet is determined with reference to the response signal. The identified condition can correspond to one of the inkjet being blocked by a particle, the inkjet being blocked by air, and the inkjet being ready to eject ink.

### TECHNICAL FIELD

This disclosure relates generally to devices that produce ink images on media, and more particularly, to devices that eject ink from inkjets to form ink images.

### BACKGROUND

Inkjet imaging devices eject liquid ink from printheads to form images on an image receiving surface. The printheads include a plurality of inkjets that are arranged in some type of array. Each inkjet has a thermal or piezoelectric actuator that is coupled to a printhead controller. The printhead controller generates firing signals that correspond to digital data for images. The frequency, amplitude, and/or duration of the firing signals affect the mass of the ink drops ejected by the printhead actuators to form an ink image that corresponds to the digital image used to generate the firing signals.

Throughout the life cycle of these inkjet imaging devices, the image generating ability of the device requires evaluation and, if the images contain detectable errors, correction. Missing inkjets or weak inkjets exemplify printhead errors that affect ink image quality. A missing inkjet is an inkjet that does not eject an ink drop in response to a firing signal. A weak inkjet is an inkjet that responds intermittently to a firing signal or that responds by ejecting ink drops having a mass that is different than the ink drop mass corresponding to the characteristics of the firing signal for the inkjet. As used in this document, “inoperative inkjets” refers to inkjets that are either missing inkjets or weak inkjets. Systems and methods have been developed that can enable inoperative inkjets to recover the ability to respond to firing signals.

Current detection methods include a test pattern being formed on an image receiving member and then digital data of the test pattern on the surface are generated. In an offset imaging device, the image receiving member is a rotating drum or belt. The digital data are produced by illuminating the drum or belt surface and generating an electrical signal that corresponds to the intensity of the light reflected from the surface. The signal is generated by an electro-optical sensor that is positioned to receive light reflected from a small portion of the drum or belt surface. By arranging a plurality of electro-optical sensors across the width of the drum or belt, the entire width can be used to generate reflected light received by the electro-optical sensors. The responses of the electro-optical sensors produce a digital image corresponding to the ink image on the drum or belt. The ink drops on the surface reflect light at an intensity that is different than the positions on the surface that do not have ink.

Evaluating a digital image produced by illuminating an image drum or belt can be difficult because the surface may generate noise in the digital image. A significant amount of image data processing is required to detect the presence of ink on an image receiving surface and to distinguish ink from defects in the image receiving surface or noise. Additionally, precise measurements of detected ink positions are required to enable the detected ink on the image receiving surface to be correlated to the inkjet that ejected the ink. Thus, significant processing resources are expended to analyze the image data of a test pattern on an image receiving surface and to correlate the data from that analysis to the identification of inoperative inkjets. Improving the ability of inkjet imaging systems to detect inoperative inkjets efficiently remains important to such systems.

### SUMMARY

A method of inkjet printer operation enables inkjets to be recovered without hindering ink image printing. The method includes delivering to the inkjet in the printhead a first signal configured to operate a piezoelectric actuator in the inkjet, receiving a second signal from the piezoelectric actuator, the second signal corresponding to a response of the piezoelectric actuator to the first signal, and identifying a condition of the inkjet with reference to the second signal, the identified condition corresponding to one of the inkjet being blocked by a particle, the inkjet being blocked by air, and the inkjet being ready to eject ink.

An inkjet printer implements the method to enable inkjet recovery without hindering ink image printing. The printer includes a printhead controller configured to generate and deliver to the inkjet in the printhead a first signal configured to operate a piezoelectric actuator in the inkjet, and a controller configured to receive a second signal from the piezoelectric actuator, the second signal corresponding to a response of the piezoelectric actuator to the first signal, and identify a condition of the inkjet with reference to the second signal, the identified condition corresponding to one of the inkjet being blocked by a particle, the inkjet being blocked by air, and the inkjet being ready to eject ink.

### BRIEF DESCRIPTION OF THE DRAWINGS

The foregoing aspects and other features of a system and method that enable inoperative inkjet detecting without image data analysis are explained in the following description, taken in connection with the accompanying drawings.

FIG. 1 is a schematic diagram of a printhead assembly used in a printer implementing the process of FIG. 4.

FIG. 2 is a graph of an example of a firing signal and a clearing signal.

FIG. 3 is a schematic diagram of an exemplary interface for detecting the response of a plurality of actuators to a driving signal.

FIG. 4 is a flow diagram of a process for detecting inoperative inkjets.

FIG. 5A, FIG. 5B, and FIG. 5C are representations of responses of a piezoelectric transducer under different load conditions.

FIG. 6 is a schematic diagram of a prior art printer in which the process of FIG. 2 can be implemented.

### DETAILED DESCRIPTION

For a general understanding of the environment for the system and method disclosed herein as well as the details for the system and method, reference is made to the drawings. In the drawings, like reference numerals have been used throughout to designate like elements. As used herein, the word “printer” encompasses any apparatus that produces ink images on media, such as a digital copier, bookmaking machine, facsimile machine, a multi-function machine, or the like. As used herein, the term “process direction” refers to a direction of travel of an image receiving surface, such as an imaging drum or print medium, and the term “cross-process direction” is a direction that is perpendicular to the process direction along the surface of the image receiving surface. Also, the description presented below is directed to a system for detecting inoperative inkjets in an inkjet printer from the responses of the inkjet actuators to driving signals. The reader should also appreciate that the principles set forth in this description are applicable to similar imaging devices that generate images with pixels of marking material.

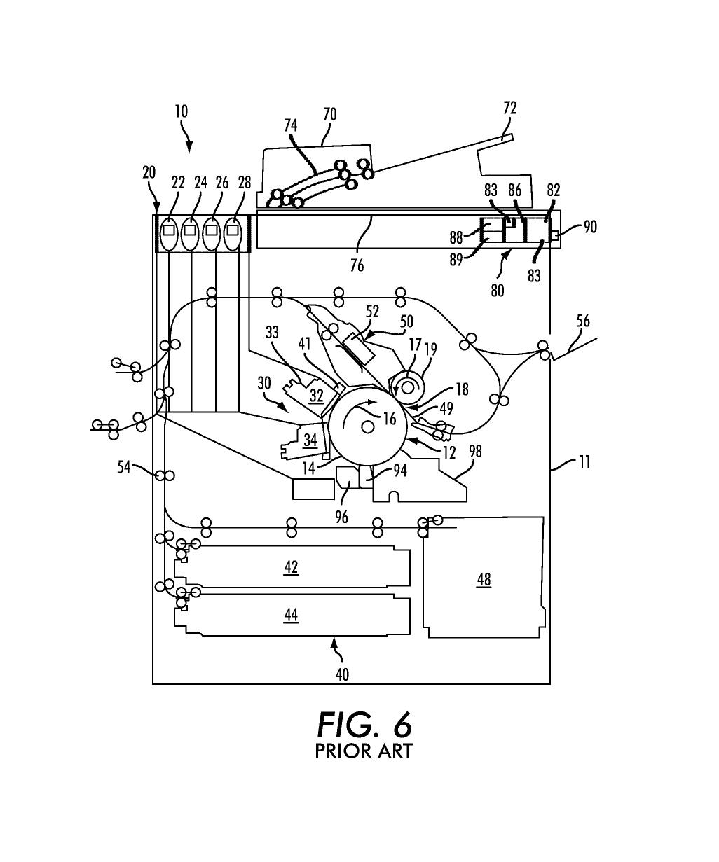

As shown in FIG. 6, a particular prior art printer 10 includes a frame 11 to which are mounted directly or indirectly all of the operating subsystems and components of the printer 10, as described below. The printer 10 further includes a rotating intermediate image receiving member 12 that has an imaging surface 14 movable in the direction 16, and on which phase change ink images are formed. A transfix roller 19 rotatable in the direction 17 is loaded against the surface 14 of image receiving member 12 to form a nip 18, within which ink images formed on the surface 14 are transfixed onto a heated media sheet 49.

The printer 10 also includes a phase change ink delivery system 20 that has at least one source 22 of one color phase change ink in solid form. The printer 10 shown is a multicolor image producing machine. The ink delivery system 20 includes four (4) sources 22, 24, 26, 28, representing four (4) different colors CMYK (cyan, magenta, yellow, black) of phase change inks. The ink delivery system 20 also includes a melting and control apparatus (not shown) for melting or phase changing the solid form of the phase change ink into a liquid form. The phase change ink delivery system is suitable for supplying the liquid form to a printhead system 30 including at least one printhead assembly 32. The printer 10 shown is a wide format high-speed, or high throughput, multicolor image producing machine. The printhead system 30 includes multiple multicolor ink printhead assemblies 32, 34. In the embodiment illustrated, each printhead assembly includes a plurality of independent printheads.

As further shown, the printer 10 includes a substrate supply and handling system 40. The substrate supply and handling system 40, for example, can include sheet or substrate supply sources 42, 44, 48, of which supply source 48, for example, is a high capacity paper supply or feeder for storing and supplying image receiving substrates in the form of cut media sheets 49, for example. The substrate supply and handling system 40 also includes a substrate handling and treatment system 50 that has a substrate heater or pre-heater assembly 52. The substrate supply and handling system 40 further includes a media transport 54, such as media transport rollers, for moving media 49 through the printer 10 from the supply sources 42, 44, 48 to a discharge area 56. The printer 10 as shown can also include an original document feeder 70 that has a document holding tray 72, document sheet feeding and retrieval devices 74, and a document exposure and scanning system 76.

Operation and control of the various subsystems, components, and functions of the printer 10 are performed with the aid of a controller 80. The controller 80, for example, is a self-contained, dedicated minicomputer having a central processor unit (CPU) 82 with electronic storage 84, and a display or user interface (UI) 86. The controller 80, for example, includes a sensor input and control circuit 88 as well as a pixel placement and control circuit 89. In addition, the CPU 82 reads, captures, prepares, and manages the image data flow between image input sources, such as the scanning system 76, or an online or a work station connection 90, and the printhead assemblies 32, 34. As such, the controller 80 is the main multi-tasking processor for operating and controlling all of the other printer subsystems and functions.

The printer controller 80 further includes memory storage for data and programmed instructions. The controller 80 can be implemented with general or specialized programmable processors that execute programmed instructions. The instructions and data required to perform the programmed functions can be stored in memory associated with the processors or controllers. The processors, their memories, and interface circuitry configure the controllers to perform the functions, such as the test signal generation and the return signal analysis, described more fully below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in VLSI circuits. Also, the circuits described herein can be implemented with a combination of processors, ASICs, discrete components, or VLSI circuits.

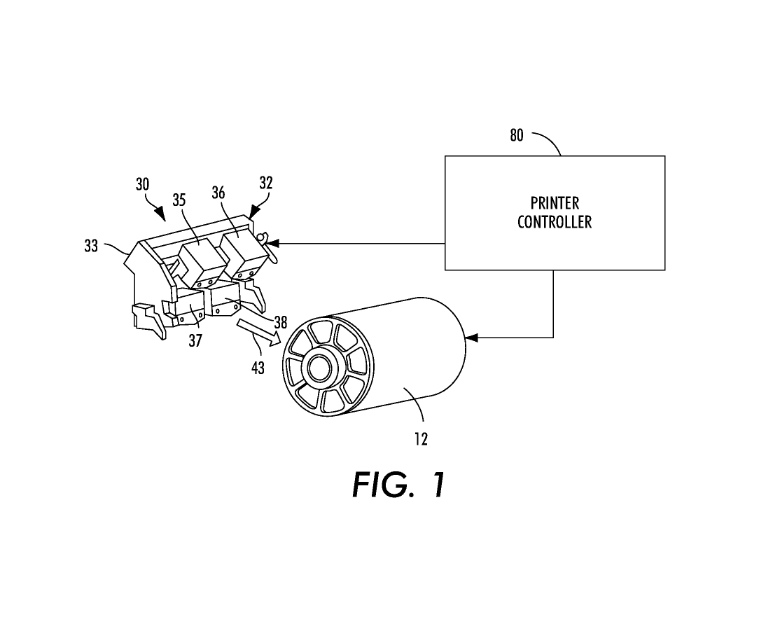

Using like reference numbers for like components and referring to FIG. 1, a schematic diagram of the components operated by the controller 80 to identify inoperative inkjets from the analysis of return signals from inkjet actuators is shown. The printhead assembly 32 includes four printheads 35, 36, 37, 38. Typically, each of these printheads ejects ink, indicated by arrow 43, to form an image on the image receiving member 12. The four printheads are arranged in a two by two matrix with the printheads in one row being staggered with reference to the printheads in the other row. Although the embodiment shown depicts a printhead assembly having four printheads, solid ink printers can have one or any number of any size printheads arranged in any practical manner. The printheads 35, 36, 37, 38 of the printhead assembly 32 are operatively connected to a support member 33 to position the printheads across a width of the image receiving member 12 that extends in the cross-process direction. To permit movement of the printheads 35, 36, 37, 38 across the image receiving member 12, the printer 10 further includes an actuator (not shown), which is coupled to the support member 33. This actuator is configured to move the support member 33 transversely to the process direction to move the printheads in a cross-process direction across the width of the image receiving member 12.

The rotating intermediate image receiving member 12 can be a rotating drum, as shown in the figures, belt, or other substrate for receiving ink ejected from the printheads. Alternatively, the printheads can eject ink onto cut or continuous media 49 moving along a path adjacent to the printheads. To rotate or otherwise move the image receiving member 12, the printer 10 further includes another actuator (not shown), which is coupled to the image receiving member 12. Controlled firing of the inkjets in the printheads 35, 36, 37, 38 in synchronization with the rotation of the image receiving member 12 enables the formation of a single continuous horizontal bar across the width of the image receiving member 12. When occurring in synchronization with multiple consecutive rotations of the image receiving member 12, controlled firing of the inkjets and controlled actuation of the printhead assembly 32 in the cross-process direction enable a single inkjet to form a single continuous horizontal bar over different portions of the image receiving member 12. Similarly, controlled firing of the inkjets at a given frequency without actuation of the printhead assembly 32 enables a single inkjet to form a single continuous vertical bar extending in the process direction. Depending on the rotational speed of the image receiving member 12 and the firing frequency capability of the printheads, the vertical line can be formed in a single rotation of the image receiving member 12 or in multiple consecutive rotations of the image receiving member 12.

To generate an image, the controller 80 renders a digital image stored in a memory of the printer and generates inkjet firing signals and printhead actuation profiles with reference to the digital image data. The firing signals are delivered to the printheads 35, 36, 37, 38 in the assembly 32 to operate the piezoelectric actuators of the inkjets in the printheads to eject ink selectively. The actuation profiles are delivered to the actuator coupled to the printhead assembly to control movement of the printhead assembly 32 in the cross-process direction. The controller 80 is coupled to the image receiving member 12 to control the rate and direction of rotation of the image receiving member 12.

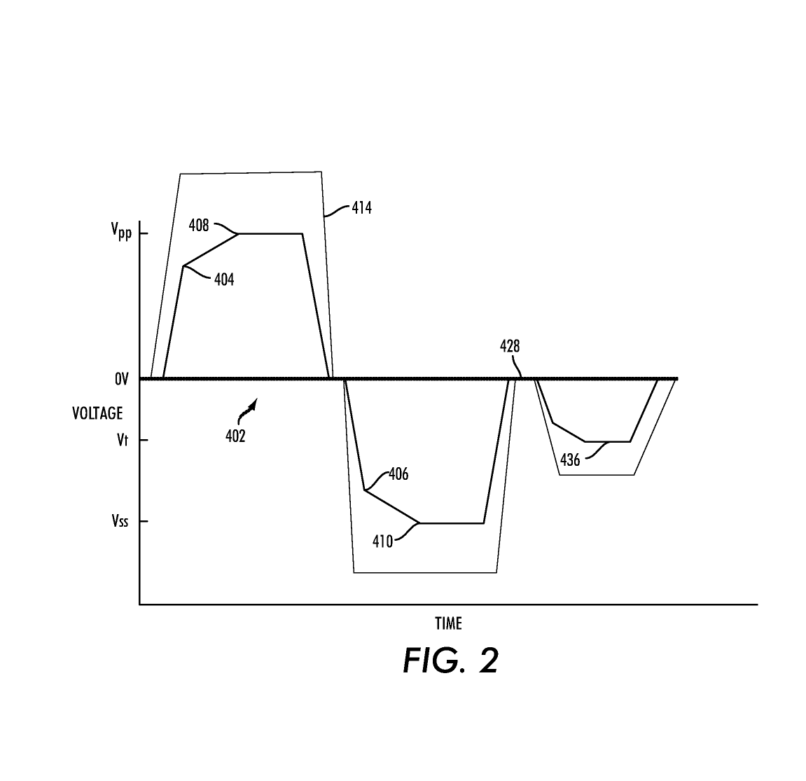

A firing signal for ink image printing and a clearing signal are shown in FIG. 2. A firing signal, as noted above, activates an actuator for an inkjet to eject ink from an inkjet for the formation of an inkjet image. A clearing signal is used to stimulate the actuator in an effort to clear a passageway through the inkjet that may be blocked by debris, air, or both. In both waveforms, the voltage of the firing signal 402 increases at a first rate to a first inflection voltage 404, and then increases at a lower rate to a peak voltage Vₚₚ 408. The firing signal remains at the peak voltage for a predetermined time period before changing to a negative voltage with a negative voltage inflection voltage 406, and a negative peak voltage 410. In FIG. 2, the waveform for the peak voltage Vₚₚ and negative peak voltage Vₛₛ have substantially identical magnitudes and waveform shapes with different polarities. The change in voltage between Vₚₚ and Vₛₛ is referred to as a “peak-to-peak” portion of the electrical signal. After generating the Vₛₛ voltage for the predetermined time period, the waveform returns to zero voltage 428 and then drops a second time to an inflection point 432 and tail voltage Vₜ 436. The magnitude of the tail voltage is less than the magnitude of the peak voltages Vₚₚ and Vₛₛ and the polarity of the tail voltage may be either positive or negative. In an exemplary embodiment, the magnitudes for Vₚₚ and Vₛₛ are in a range of approximately 30 to 50 volts and the magnitude of Vₜ is between approximately 10 and 20 volts, although alternative ink ejector configurations operate with various voltage levels.

The clearing signal 414 has a similar shape as the firing signal 402, but is configured differently to generate more ejecting energy from an inkjet. In the example of a clearing signal 414, the clearing signal has both an amplitude that is greater than the firing signal amplitude and a duration for the peak-to-peak portion and the tail voltage that is longer than the firing signal as well as a slope that is steeper than that of the firing signal. In other embodiments, any one of the duration, slope, and amplitude can be adjusted in a manner that enables the inkjet ejector that receives the signal to generate more ejecting energy in an effort to clear the inkjet ejector of debris and/or air entrained in the ink and to restore the inkjet ejector to an operative state.

In previously known printers, the controller generates firing signals with reference to test pattern data stored in the printer to operate inkjets in the printheads of the printhead assembly to generate a test pattern on the surface of the intermediate image receiving member. An electro-optical sensor then generates digital image data of the test pattern on the image receiving member surface and a processor in the printer analyzes the image data to detect the absence of ink drops or irregular placement or size of ink drops to identify inkjets that are inoperative. In an improved printer described below, the identification of inoperative inkjets is made with reference to the response of an inkjet actuator to a firing, clearing, or other driving signal.

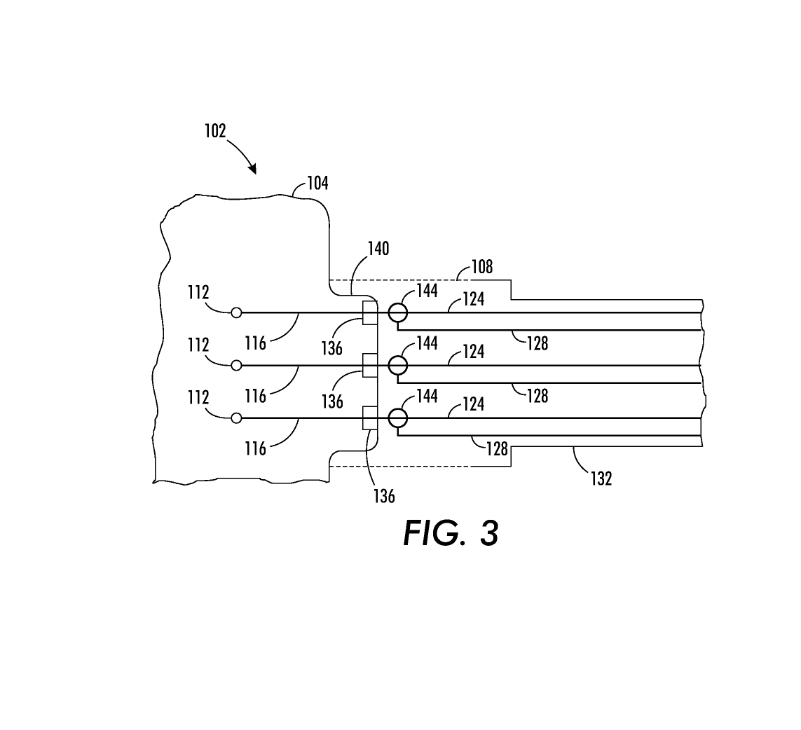

FIG. 3 depicts an interface 102 that enables inkjet actuators to be activated and the response of the actuators captured. The interface 102 includes a portion of an electrical circuit board (ECB) 104 and a connector 108. The ECB 104 is located within a printhead, such as one of the printheads 35 to 38 in FIG. 1. The portion of the ECB 104 shown in FIG. 3 has three inkjet actuators 112, each of which is electrically connected by electrical traces 116 to an edge of the ECB 104 at connector tab 140. The electrical connector 108 can be selectively mounted to the tab 140 to enable terminals 136 to provide electrical contact between the electrical traces 116 and the electrical conductors 124 within cable 132. These electrical conductors are operatively connected to a printhead controller to enable the printhead controller to deliver firing, clearing, or other driving signals to the actuators. The connector 108 also includes electrical conductors 128 that terminate into inductive rings 144 that surround the electrical conductors 124 at some position inside the connector 108. Although the figure shows the inductive rings as being positioned at or near the terminal end of the conductors 124 engaging the ECB 104, the inductive rings can be located at or near the other terminal end of the conductors 124. These inductive rings are configured to pick up electrical signals in the conductors 124 that are induced in the traces 116 by the actuators 112 in response to the actuator being distended by a driving signal. These induced electrical signals are delivered to the printhead controller for analysis as discussed in more detail below. Although one example of an interface to deliver actuator responses has been shown, other interfaces can be used to pick up electrical signals generated by the response of an actuator to a firing or other driving signal.

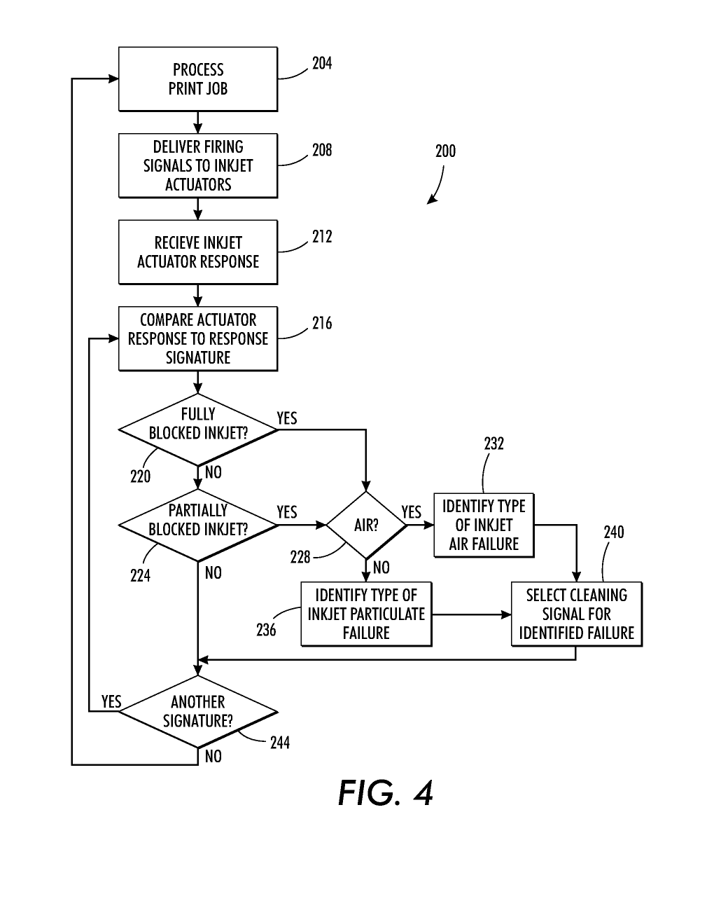

A process for detecting inoperative inkjets from the responses of the actuators to driving signals is shown in FIG. 4. As used below, a statement that the process does or performs some function refers to the controller implementing the process executing programmed instructions in a memory operatively connected to the controller that cause the process to operate one or more components operatively connected to the controller to perform function. The process 200 begins as the controller 80 that operates a printer processes print jobs (block 204). Processing print jobs refers to the controller operating a print engine to render image data and generating corresponding firing signals that are delivered to inkjet actuators within printheads to eject ink onto an image receiving surface to form an ink image (block 208). The responses of the actuators to the firing signals are picked up by the inductive rings and delivered to the printhead controller (block 212). Each of these responses is compared to one or a plurality of response signatures stored in a memory operatively connected to the printhead controller (block 216). Each response is compared to a group of response signatures that enables the process to identify the inkjet as fully blocked (block 220) or partially blocked (block 224). Additionally, the process identifies the fully blocked or partially blocked inkjet as being blocked by air or particulate matter (block 228). The inkjet failure is then identied from these comparisons (blocks 232 and 236) and an appropriate clearing signal is selected (block 240). Of course, if the inkjet is not detected as being fully or partially blocked, then the inkjet is operative and the process checks for another response signature to analyze. Once an inoperative inkjet is identified, the process then determines whether another response is to be analyzed block (244) and the process continues the analysis (block 216) if another response signature remains for analysis. Otherwise, the next print job is processed (block 204), but now those inkjets that were identified as being inoperative inkjets having the selected clearing signals delivered to them while the operative inkjets for generation of an ink image are delivered firing signals for that purpose.

The description of an inkjet as being partially or fully blocked by air refers to a condition in which air in an ink passage reduces or nullifies the pumping action of the energized inkjet actuator. This loss in pumping action effectiveness arises from the compressive nature of air. Thus, the effective ejecting operation of an inkjet is blocked or reduced until the air, which can be in the form of a bubble or larger volume, is either reduced in size or eliminated. Various methods of purging air from a printhead are known in the art, but the significance to the methods and devices presented in this document is that the condition can be detected so an appropriate corrective action or actions can be taken.

The response signatures stored in the memory are digital data corresponding to a response of an actuator to a driving signal in different situations. In one embodiment, a response signature of an operative inkjet is stored in the memory along with the response signature for an inkjet blocked by air, an inkjet blocked by particulate matter, an inkjet partially blocked by air, and an inkjet partially blocked by particulate matter. These response signatures are determined empirically by driving the inkjet actuators in multiple printheads, collecting the response signatures, and comparing the changes in the response signatures for inkjets identified as being inoperative from known digital imaging analysis. Additionally, inkjets can be intentionally blocked with particulate matter or air and operated with driving signals to obtain a collection of response signatures in these conditions. One or more of these response signature collections can be statistically analyzed to identify response signatures for each of the categories noted above that are significant statistically. Also, driving signals that are different sufficiently from firing signals in one or more of amplitude, frequency, or duration that they activate the actuators without causing an ink drop to release from the inkjet can be used and the responses analyzed. These driving signals are useful in that they can be used to operate inkjets not used to produce an ink image without producing any evidence of the inkjet being activated in the ink image. Thus, inkjets not be used to generate an ink image can be tested without producing visual noise or adversely impacting image quality in the image being produced. Of course, the responses of actuators to these driving signals must be captured and statistically analyzed so appropriate response signatures can be stored in the memory operatively connected to the controller that implements the process 200.

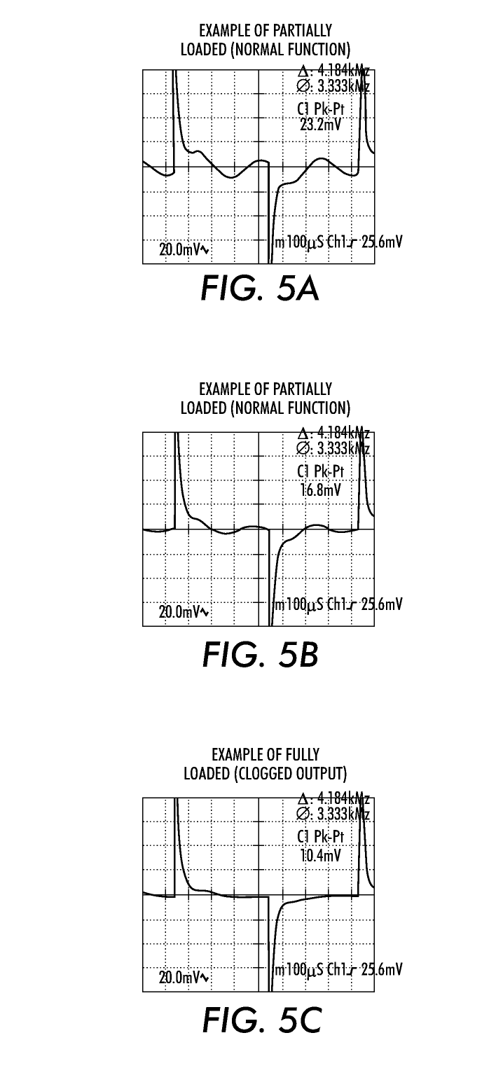

Examples of response signatures are shown in FIG. 5A, FIG. 5B, and FIG. 5C. Each figure shows a response of a piezoelectric transducer under different load conditions. In FIG. 5A, the response signature 504 is for an unloaded piezoelectric transducer such as occurs when the piezoelectric transducer acts on an air bubble. In FIG. 5B, the response signature 508 is for a partially loaded piezoelectric transducer such as occurs during a normal firing of an inkjet. In FIG. 5C, the response signature 512 is for a fully loaded piezoelectric transducer such as occurs when an inkjet is clogged. These responses or statistical representations of a response type, such as an average of a group of partially loaded transducers, are stored for comparison to actuator responses received by the controller.

The selection of a clearing signal noted above is made with reference to the identification of the type of inoperative inkjet. This identification enables the process to select a clearing signal with empirically determined characteristics that are better for one type of inoperative condition than another clearing signal. As previously noted, any one of the duration, slope, and amplitude of a clearing signal can be adjusted in a manner that enables the inkjet ejector that receives the signal to generate more ejecting energy in an effort to clear the inkjet ejector of debris and/or air entrained in the ink and to restore the inkjet ejector to an operative state. These aspects of a clearing signal can be empirically determined for different types of blocked inkjets.

Any specific attempt to use a clearing signal to accomplish the clearing of an inkjet may or may not be successful in operating the actuator in the inkjet to eject a clearing volume of ink with the expected ink mass. Repetitive attempts can increase the clearing effectiveness in incremental fashion or one attempt may successfully restore normal function. Additionally, the response signature to another type of response signature. If so, the clearing signal can be changed to correspond to the newly detected response signature and the clearing signal delivered to the inkjet during the next print job. A count of consecutive clearing signal operations of each identified inoperative inkjet can be maintained and used to determine whether an inkjet cannot be recovered by use of a clearing signal. For those inkjets that cannot be recovered by a clearing signal, an inoperative inkjet map and accumulated inoperative inkjet count can be kept. The inkjet map enables the printer to substitute other inkjets for the inkjets that cannot be recovered. Once the inoperative inkjet count exceeds some predetermined threshold, then the controller determines a purge maintenance procedure is required and a signal is generated to notify an operator or user that the printer is being taken out of service for a purge maintenance procedure. Alternatively, the controller can be configured to notify the operator of the condition and receive a signal from a user interface that enables the controller to continue operation of the printer for continued printing.

In operation, the connectors that electrically connect a printhead controller to a printhead are configured as shown in FIG. 3 or in some manner that enables actuator responses to be received by a controller of the printer. The controller of the printer and the printhead controllers that generate firing signals are configured with programmed instructions and electronic components to implement the process 200. Thereafter, the controller executes the instructions during the processing of print jobs to detect inoperative inkjets. While continuing to process and print the print jobs, the controller identifies inoperative inkjets, operates the identified inkjets with clearing signals, and evaluates responsive signatures to determine whether the inkjets have been cleared. If the number of inoperative inkjets failing to respond to the clearing signal and recover their ejecting ability reaches the predetermined maximum, the controller notifies the operator a purge maintenance procedure is required. Processing of print jobs can be suspended until the purge maintenance procedure is performed. Thereafter, the controller returns the printer to operational mode for processing print jobs.

It will be appreciated that variants of the above-disclosed and other features, and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A method for identifying a condition of an inkjet in a printhead comprising:
delivering to the inkjet in the printhead a first signal configured to operate a piezoelectric actuator in the inkjet;
receiving a second signal from the piezoelectric actuator, the second signal corresponding to a response of the piezoelectric actuator to the first signal; and
identifying a condition of the inkjet with reference to the second signal, the identified condition corresponding to one of the inkjet being blocked by a particle, the inkjet being blocked by air, and the inkjet being ready to eject ink.

2. The method of claim 1, the condition identification further comprising:
comparing the second signal to data stored in a memory to identify the condition.

3. The method of claim 1, the condition identification further comprising:
identifying a difference between the second signal and data stored in a memory that corresponds to an expected second signal.

4. The method of claim 1, the condition identification further comprising:
identifying the condition with reference to a voltage amplitude of the second signal.

5. The method of claim 1, the condition identification further comprising:
identifying the condition with reference to a frequency of the second signal.

6. The method of claim 1, the condition identification further comprising:
identifying the condition with reference to a decay time of the second signal.

7. The method of claim 1, the condition identification further comprising:
identifying the condition with reference to a profile of the second signal.

8. The method of claim 1 further comprising:
applying a third signal configured to operate the piezoelectric actuator to clear one of the particle and air from the inkjet in response to the identified condition indicating the inkjet is blocked.

9. The method of claim 8 further comprising:
generating the third signal with at least one of a voltage amplitude, frequency, and duration being greater than the corresponding voltage amplitude, frequency, or duration of the first signal.

10. An apparatus for identifying a condition of an inkjet in a printhead comprising:
a printhead controller configured to generate and deliver to the inkjet in the printhead a first signal configured to operate a piezoelectric actuator in the inkjet;
a controller configured to receive a second signal from the piezoelectric actuator, the second signal corresponding to a response of the piezoelectric actuator to the first signal, and identify a condition of the inkjet with reference to the second signal, the identified condition corresponding to one of the inkjet being blocked by a particle, the inkjet being blocked by air, and the inkjet being ready to eject ink.

11. The apparatus of claim 10, the controller being further configured to compare the second signal to data stored in a memory to identify the condition.

12. The apparatus of claim 10, the controller being further configured to identify a difference between the second signal and data stored in a memory that corresponds to an expected second signal.

13. The apparatus of claim 10, the controller being further configured to identify the condition with reference to a voltage amplitude of the second signal.

14. The apparatus of claim 10, the controller being further configured to identify the condition with reference to a frequency of the second signal.

15. The apparatus of claim 10, the controller being further configured to identify the condition with reference to a decay time of the second signal.

16. The apparatus of claim 10, the controller being further configured to identify the condition with reference to a profile of the second signal.

17. The apparatus of claim 10, the printhead controller being further configured to apply a third signal configured to operate the piezoelectric actuator to clear one of the particle and air from the inkjet in response to the identified condition indicating the inkjet is blocked.

18. The apparatus of claim 17, the printhead controller being further configured to generate the third signal with at least one of a voltage amplitude, frequency, and duration being greater than the corresponding voltage amplitude, frequency, or duration of the first signal.
